(19) United States
(12) Patent Application Publication
(10) Pub. No.: US 2023/0331403 A1
(43) Pub. Date: Oct. 19, 2023

(54) METHOD, DEVICE AND COMPUTER PROGRAM PRODUCT FOR DETERMINING THE POSITION OF A SPACECRAFT IN SPACE

(71) Applicant: JENA-OPTRONIK GMBH, Jena (DE)

(72) Inventors: Uwe Schmidt, Buergel (DE); Falk Ahlendorf, Rothenstein-Oelknitz (DE); Rolf Hartmann, Jena (DE)

(73) Assignee: JENA-OPTRONIK GMBH, Jena (DE)

(21) Appl. No.: 18/043,355

(22) PCT Filed: Aug. 23, 2021
(86) PCT No.: PCT/EP2021/073241

§ 371 Date: Feb. 28, 2023

(30) Foreign Application Priority Data
Aug. 31, 2020 (DE) 10 2020 122 748.5

(51) Int. Cl. B64G 1/36; B64G 1/28

(52) U.S. Cl. CPC B64G 1/361; B64G 1/288

(57) ABSTRACT

A method for determining the position of a spacecraft in space, includes cyclically÷ repeating steps of capturing distorted star images; processing the distorted star images to form distorted star group data; storing the distorted star group data; determining a current rotation rate by comparing the distorted star group data of two consecutive cycles; transmitting the current rotation rate to a position control system; and/or the following steps are carried out: processing the distorted star images of a current cycle to form rectified star group data; determining position information by matching the rectified star group data with star group catalog data which is carried along; transmitting the position information to the position control system. A method for determining the position of a spacecraft in space, taking into account known system parameters of an optical system, includes: coding star group catalog data with n = 3...4 stars [xₙ, yₙ, z_{n]}, which are visible in an image field, into representative focal-plane coordinates; forming a scaling-, translation-, and rotation-invariant star group code on the basis of [xPiX,yPiX]n; or coding star group catalog data with n = 3...4 stars [xₙ,yₙ, z_{n]}, which are visible in an image field, into representative tangent and/or angular coordinates [tan(a),tan(β)]ₙ. The invention further relates to a device for carrying out such methods and to a computer program product for carrying out such methods.

### CROSS REFERENCE TO RELATED APPLICATIONS

This application is a national phase application under 35 U.S.C. §371 of International Patent Application No. PCT/EP2021/073241, filed Aug. 23, 2021 (pending), which claims the benefit of priority to German Patent Application No. DE 10 2020 122 748.5, filed Aug. 31, 2020, the disclosures of which are incorporated by reference herein in their entirety.

### TECHNICAL FIELD

The invention relates to methods for determining the position of a spacecraft in space. The invention also relates to a device for carrying out such a method. The invention also relates to a computer program product for carrying out such a method.

### BACKGROUND

Document US 2011/0024571 A1 relates to a system and method for the gyro-less transmission of the sun detection from the transfer orbit using only the feedback of the vane current measurement. The transfer orbit serves to transport the spacecraft into its operational orbit. In this case, the spacecraft is set in a specific rotation, wherein the axis of rotation and the rotation speed are determined optimally solely from the measurement of the available solar current. No other sensors, such as gyroscopic sensors, star sensors, or sun sensors, are used in the transfer orbit. As a result, this mission phase, which is risky due to low availability of resources and fatal consequences of incorrect control, can be designed very safely. However, the low accuracy of the rotation rate measurement and the necessary stable rotation do not allow dispensing with gyroscopic sensors in general in all mission phases.

Document US 2014/0231589 A1 relates to a position estimator, which uses the sun sensor outputs as single position determination measurements to provide three-axis position information. The underlying object in this case is that, in principle, only two of the three components of the position can be measured with sun sensors. The solution consists in the estimation of the third position component using the measurements of several sun sensors and the moment of inertia of the craft. Here too, there is again the restriction to a stable rotation of the spacecraft and the limited measurement accuracy of sun sensors, which is not sufficient for all mission phases.

Document US 8,380,370 B2 relates to a system and a method for controlling a space vehicle for performing a three-axis maneuver, which is based purely upon “position” (i.e., position) measurements. The aim is to replace gyroscopic sensors with star sensors. The required maneuvers of the space vehicle are to take place solely with the rotational position measurements, without using rotation rate measurements. In order to achieve this, the rotation rates used in the maneuvers must remain under the upper limit of the usability of conventional star sensors of a few angular degrees per second. For this purpose, for various modes of control of the space vehicle, such as sun input mode, safety mode, and normal mode, rotation commands are generated, which consist of consecutive phases of particular rotations. The rotation commands are defined in partial rotations by the individual Euler angles, using a cardan model of the rotation. In doing so, low rotation rates are maintained in each phase. Under these circumstances, the measured values from conventional star sensors are sufficient for determining the commands with the respective phases. The command generation includes protective measures against the failure of the star sensors involved. During a failure, the command phases are aborted, and no rotations are carried out. After restoration of the star sensor measurement, an extra phase is inserted, which restores the state before the failure with a predetermined rotation rate. The specified solution cannot completely replace the gyroscopic sensors, since it does not work at high rotation rates. The use is therefore provided only as an emergency solution in the case of the unavailability of data of the gyroscopic sensors, which are present in principle.

Document US 7,410,130 B2 relates to a method for determining the flight position of a rotating space vehicle. This involves the use of star sensors for the control of rotationally-stabilized space vehicles, without the aim of completely replacing gyroscopic sensors. A rotation rate of 3 angular degrees per second is specified as the upper limit of the usability of conventional star sensors. In order to still remain below this limit during the failure of the motors of the space vehicle, only rotation rates in the range of 0.3 to 1.5 angular degrees per second are used for the rotational stabilization, although higher rotation rates would lead to better stability. For unforeseen errors, e.g., if the motor of the space vehicle not only fails, but is impermissibly accelerated as a result of errors in the control, rotation rates of up to 20 angular degrees per second occur. This value is far above the usage limit of conventional star sensors and has hitherto excluded them from use as an emergency sensor in place of gyroscopic sensors. According to US 7,410,130 B2, the position measurement of the space vehicle is first initialized with the aid of star sensor data. For the initialization of the position measurement, the space vehicle must be set in a stable rotation at a rotation rate under the usage limit of conventional star sensors. In the position estimation following initialization, a plurality of sensor and control components are used: Earth sensors, sun sensors, gyroscopic sensors, solar current sensors, Kalman filters, position controllers, and ground-based position measurements. By linking the plurality of components, it is to be achieved that there is no need to provide two different variants of the sensors for the transfer orbit and for the deployment orbit. For example, a rotating sun sensor has hitherto been used for the transfer orbit, and a wide-angle sun sensor has hitherto been used in the deployment orbit. This results in an advantageous reduction in mass, costs, and failure probability. In the event of loss of the position information, however, a new initialization by the star sensor, in conjunction with the corresponding stabilization of the rotation, must be performed in the method from document US 7,410,130 B2. The star camera is also not available as a sensor for this stabilization; an additional gyroscopic sensor must be used for the measurement above the usage limit of conventional star sensors.

Document US 9,073,648 B2 relates to a position estimator which uses star-tracking measurements and improved Kalman filtering with or without position data, in order to supply three-axis rate estimates. In this case, the rotation rate can also be estimated directly from the star positions, without determining the rotational position. The estimation of the rotation rate from star positions is referred to here as very unreliable if adequate estimation algorithms are not applied. The estimation algorithms proposed in document US 9,073,648 B2 contain Kalman filters and averagings in the forward and backward direction over a time interval. Only after this improvement can the filtered rotation rates be used to calculate the rotational position, and to compensate for the failures of gyroscopic sensors. The unreliability of the rotation rate measurement from star positions without position determination results from the star positions having to be tracked in the image sequence of the star camera. The tracking consists in predicting the coming star position in advance and finding the star again in the vicinity of the predicted position. At high rotation rates and rotation accelerations, confusion as to the star being tracked can easily occur. In addition to the Kalman and average filtering, a step of matching star pairs is additionally provided in the position estimator according to document US 9,073,648 B2. This matching takes place without identification of the stars and without the position calculation. The success of the method specified in document US 9,073,648 B2 depends upon the inclusion of many stars and the consideration of parameters of the position control of the spacecraft. The improved reliability of the rotation rate estimation is not sufficient, in general, to save on gyroscopic sensors on the spacecraft. According to US 9,073,648 B2, the rotation rate information from the star sensor can be used only for calibrating the gyroscopic sensors and for restricted functions in the event of the unexpected failure of gyroscopic sensors.

The publication, WHITE PAPER “ Global shutter, Rolling Shutter -Functionality and Characteristics of Two Exposure Methods (Shutter Variants),” Dominik Lappenküper, www.baslerweb.com, 2018, deals with the characterization of the global shutter and the rolling shutter for exposure control in modern CMOS cameras. In the global shutter, all cells of the matrix are exposed once simultaneously, whereas the rolling shutter exposes the individual image lines one after the other, line for line. Depending upon the exposure time, overlaps can occur in the case of the rolling shutter if the exposure of the next line begins before the conclusion of the exposure of the preceding image line. Cameras with a global shutter require 2 to 3 times as many transistors for control and charge transport on the sensor chip than do cameras with a rolling shutter. As a result, comparatively high image noise, more heat, and a strong susceptibility to the radiation loads in the orbit arise in the case of the global shutter.

A disadvantage of the rolling shutter - especially on fast-moving platforms - is that of image distortions which may exceed the acceptable degree for star identification. The advantages of the rolling shutter predominate for the use in space. A rolling shutter is also a prerequisite for specific optimizations for increasing the image quality. For example, document US 2006/0238632 A1 specifies a method for preventing blooming in CMOS cameras. During use with star sensors, blooming occurs if very bright objects, e.g., solar reflections by parts of the spacecraft, lead to an overexposure, in which no longer can all photons be converted into measurable electrons. The excess electrons then pass into adjacent cells and lines, as a result of which incorrect measured values are produced. The solution in accordance with document US 2006/0238632 A1 prevents the overflow by special, multiple resets of the image lines, which is possible only in the case of a rolling shutter.

Document US 9,503,653 B2 relates to a method for determining the position of a star sensor on the basis of a rolling-shutter image. The strong restriction of the dynamics of the spacecraft to the low rotation rate for tolerable image distortions by the rolling shutter is referred to in document US 9,503,653 B2 as the most important barrier to the development of conventional star sensors. According to document US 9,503,653 B2, high rotation rates are the decisive bottleneck for high-resolution Earth observation missions. According to document US 9,503,653 B2, the rotational position measurement for star cameras with a rolling shutter is to be improved in a three-stage method under conditions of high dynamics. In this case, the star sensor is in the window mode in which not the entire image, but only the image windows of interest, are read out for predicted star positions. The three stages proceed in the sequence of the extraction of the individual navigation stars and not in the usual star sensor cycle, which results from the evaluation of the entire image field. The first step comprises the optimization of the time parameters of the rolling shutter for the extraction of the next navigation star, i.e., the optimization of the exposure time, the readout time, the line transition time, and the processing time. In the second step, for the optimized parameters, the position of the next navigation star is estimated from the star catalog in the sensor matrix, and the star image is extracted there. In the third, final step, the rotational position and the rotation rate are re-estimated recursively with the new star and the previous estimation. The optimization of the time parameters of the rolling shutter serves, inter alia, to maintain a constant star sensor cycle for compatibility with conventional star sensors and the unambiguous definition of the time of the next star extraction. The advantages of the solution according to document US 9,503,653 B2 are considered to be that the measured values are estimated and output faster by an order of magnitude with the single star cycle than with the star sensor cycle. Furthermore, shorter star sensor cycles are to be achieved, since the good predictability of the star windows saves on the exposure and the reading out of the entire image matrix. The method described in document US 9,503,653 B2 provides only extrapolations of the rotational position and the rotation rate and cannot be used for the initial acquisition when initial values for the rotational position and the rotation rate are missing. A further disadvantage is the dynamic setting of the time parameters of the rolling shutter. This setting is not possible with all cameras, and complicates the camera structure.

So-called autonomous star sensors have been used for many years. They are the development of the star trackers. Autonomous star sensors not only track the stars in the image sequence of the star camera, but also determine the absolute rotational position of the star sensor from the star positions. In the case of star trackers, the position calculation is carried out in the central computer of the satellite, and not in the sensor. The identification of the tracked stars is necessary for the rotational position calculation. Star identification means that the stars in the star camera image are unambiguously matched to the stars of a global star map. The star map is carried along in the sensor in the form of a star catalog. Modern autonomous star sensors can determine the star identification without any advance information, such as the approximate viewing direction of the camera. This capability is called lost-in-space identification. The methods of lost-in-space identification essentially determine the quality of a star sensor and are therefore the subject matter of permanent developments. The study, “A Survey on Star Identification Algorithms,” Benjamin B. Spratling et al., Algorithms 2009, 2, 93-107, provides a good overview of the changing methods of identification. According to this study, the first autonomous star sensors need approximately as many search steps for the identification of a star as there are stars in the star catalog. This has the consequence that, with such star sensors, the initial acquisition of the position cannot take place in the same rhythm as the image acquisition. The star sensor cycle of the image acquisition is generally between ⅕ of a second and 1/16 of a second. In contrast, the initial acquisition takes an order of magnitude longer. In the mid-nineties, there was a decisive breakthrough in the improvement of the identification algorithms. For the search of the star to be identified or a star group in the star catalog, instead of sequential-algorithm methods, the graph theory with index trees was used for searching. The star catalog now additionally includes an index tree and possibly a catalog of the star groups, which leads to an increase in the memory requirement. On the other hand, the number of search steps in the catalog decreases dramatically. The number of steps is no longer proportional to the catalog length - typically, about 5,000 - but corresponds to the binary logarithm of the catalog length, i.e., about 12 search steps. This improvement makes it possible to perform the lost-in-space star identification in each cycle of the image acquisition.

Document US 5,935,195 A describes a variant of the star identification with index trees. According to US 5,935,195 A, star groups which consist of 3 stars are formed from the stars in the camera image. Each star group is then characterized by at least two angular distances between stars of the group. The angular distances are selected by means of geometric classification criteria such that they unambiguously identify the star group. According to the same method, star groups are also formed from the stars of the star catalog. The star groups are stored as a database together with the characterizing angular distances in the star sensor as an extension of the star catalog. The selection of the stars for a group can take place according to geometric aspects of the neighborhood and according to the star brightness. For the search of the appropriate star group in the database, a binary index tree is used, according to document US 5,935,195 A.

As the publication, “Making the Sky Searchable: Fast Geometric Hashing for Automated Astrometry,” Sam Roweis, Dustin Lang & Keir Mierle, University of Toronto, David Hogg & Michael Blanton, New York University, http://astrometry.net, 2005-2019, discloses, in newer developments, vector index trees are used for the search. In addition to the acceleration of the search in the catalog, there are approaches to simpler and more robust methods of calculating the star group from the image of the star camera. In the document US 5,935,195 A, the calculation effort for the parameters of the star groups from the image is proportional to double the number of stars in the image, and is therefore typically at approximately 100 steps.

According to the study, “A Survey on Star Identification Algorithms,” Benjamin B. Spratling et al., Algorithms 2009, 2, 93-107, the calculation of the star groups could be reduced to the number of stars in the group, i.e., approximately 3-5. Under the term, “dimensionless” methods, the study, “A Survey on Star Identification Algorithms,” Benjamin B. Spratling et al., Algorithms 2009, 2, 93-107, mentions approaches to reducing the influence of calibration errors of the star camera. Parameters of star groups that are independent of the image scale of the camera are used for this purpose. For example, instead of the angles between the stars of a 3-star group, the inner angles of the triangle spanned by the 3 stars are used. According to the publication, “Making the Sky Searchable: Fast Geometric Hashing for Automated Astrometry,” Sam Roweis, Dustin Lang & Keir Mierle, University of Toronto, David Hogg & Michael Blanton, New York University, http://astrometry.net, 2005-2019, for a 4-star group, normalization of the star distance angles to the respectively largest angular distance of the group is applied, to achieve the independence from the image scale.

In the international project of astronomers “Astrometry.net,” a method was developed which can re-identify any image acquisitions of the starry sky without knowledge of the parameters of the image acquisition system. The method described in the source codes the entire starry sky up to magnitude 22mag in (scaling-, translation-, and rotation-)invariant star groups. With sufficiently high computing power, star images from arbitrary sources are thus possible without knowing the system of the acquisition system.

The 4-star group catalogs used for this method, and also the required computing powers, exceed the resources of a star sensor by several orders of magnitude. This is due to the fact that the above-mentioned method operates without knowledge of the parameters (field of view, sensitivity, etc.) of the image acquisition system.

Star sensors operate according to the principle of detecting point objects in the raw image data (by means of a detection threshold), of distinguishing them (star-like object from a pixel defect), of tracking them, of interpolating them, of transforming them (pixel coordinates -> angular coordinates), of identifying them (with the aid of a star catalog), and, finally, of calculating the 3-axis position. This process of the initial acquisition of the position can take several seconds and is very uncertain with high movement dynamics (rotation rate, rotation acceleration). Through the use of a system-adapted star group catalog coding using the known star sensor properties (optical system, detector), extremely short star identification times (real-time!) can be used in conjunction with efficient on-board star catalogs.

### SUMMARY

The object of the invention is to improve the method mentioned at the outset. The object of the invention is also to provide a device mentioned at the outset. The object of the invention is also to provide a computer program product mentioned at the outset.

In particular, the object of the invention is to make it possible to completely replace gyroscopic sensors in the position determination system of highly dynamic spacecraft by improvements in the star sensors. For this purpose, the usage limitations of star cameras with a rolling shutter caused by the image distortion are to be overcome, and rotational position and rotation rate measurements are to be made possible far beyond the previous rotation rate limit. In particular, the rotation rate limit is to be improved to such an extent that a gyro-less rotational position and rotation rate measurement becomes possible for all essential cases of application, up to the emergency regime. The solution according to the invention shall not require any interventions in the hardware of available star cameras, and in particular also not in their sensor-based control and preprocessing electronics, so that existing cameras can continue to be used. The rotation rate limit shall not only be improved for the rotation rate measurements with the aim of substituting gyroscopic sensors, but also for the measurement of the absolute rotational position at very high rotation rates. The solution according to the invention shall manage, without additional delays, with the minimum number of star sensor cycles, i.e., with one cycle in the continuation of the measurement in a continuous sequence and with one or two cycles under lost-in-space conditions.

In particular, the object of the invention is to convert a process of “detecting ... distinguishing ... tracking ... interpolating ... transforming ... identifying ... calculating position,” which takes several seconds - typically, about 10 s - into a real-time process of, for example, <100 ms with a 10 Hz measuring cycle. Real-time star identification requires no interference-prone star tracking - particularly at high rotation rates and rotation accelerations. In each individual measuring cycle, independent position measurements are possible, which then also enable real-time rotation rate and acceleration determination in consecutive cycles. Particular at very high rotation rates and rotation accelerations, a possibility can be provided for determining the direction of rotation and a rate estimate with a star sensor, precisely when suitable star groups (bright star fields) can be detected in at least two consecutive cycles, but do not necessarily have to be present in each cycle (when sweeping dark star fields). Conventionally implemented attitude tracking at high accelerations and rotation rates can be supported by a parallel, real-time identification with the described method.

The method can be carried out without using gyroscopes or gyro instruments. In this respect, the method or the device can also be referred to as gyro-less. The spacecraft can be a highly dynamic spacecraft.

A fundamental aspect of the invention can consist in that image distortions produced by a rolling shutter are corrected to such an extent that a star identification is also possible for very high rotation rates.

An availability of a star identification in a sensor cycle for an entire image with modern search methods can then result in a window mode no longer being required for star tracking. It can thus be prevented that star sensors fail at high rotation rates, and in particular at high rotation accelerations, due to an uncertain prediction of the window position. The requirement of a prediction of a next star position can be omitted for a re-identification performed repeatedly. It always works as long as an image geometry is still good enough that identification is possible.

In order to correct an image distortion by a rolling shutter, a rotation rate is required for rolling correction, on the one hand, and an identification, and thus a correction, is required for a rotation rate, on the other. This conflict of objectives can be solved in that the identification is not immediately performed with the geometrically correct star groups of a catalog, but first in an intermediate step with the star groups distorted according to a current rotation rate.

In the intermediate step, the rolling-distorted star groups from the current image can be found again in a quantity of the rolling-distorted star groups of the last image. This is less sensitive to rotation rates and rotation accelerations than the catalog identification, since only the change in distortion in a star sensor cycle is relevant, and no longer the entire distortion.

From the rolling-distorted star groups found again in two consecutive images, the current rotation rate can then initially be estimated sufficiently well. A position cannot be determined from this matching. This initial rotation rate is good enough for correcting the rolling distortion in the current distorted star groups in order to identify the groups in the catalog. With this identification in relation to the catalog data stored in inertial coordinates, the final determination of the rotational position and precise rotation rate of the star sensor can then take place.

With knowledge of the system parameters - in particular, focal length, pixel size, number of pixels of a star sensor or detector - a star group coding can take place. Catalog star groups with n = 3 ... 4 stars [xₙ,yₙ,zₙ], which are seen simultaneously in a field of view, can be coded into representative focal-plane coordinates, and in particular in pixel coordinates. In this case, due to the system knowledge, a requirement of further simultaneously visible stars can be dispensed with. On the basis of [xₚᵢₓ, y_{Pix}]ₙ, scaling-, translation-, and rotation-invariant star group codes can be formed. In this coding, the coordinates supplied by the detector can be used directly, without further processing. Alternatively or additionally, star group catalog data with n = 3 ... 4 stars [xₙ,yₙ,zₙ], which are visible in an image field, can be coded into representative tangent and/or angular coordinates [tan(α),tan(β)]ₙ.

In particular, only the brightest stars are selected for the catalog star group formation. The use of the brightest stars reduces the quantity of stars and increases the significance/tolerance of the star groups. Measurement inaccuracies can thus be tolerated and advantageously used. The measured star groups may be erroneous with respect to a single star position as a result of: measurement noise in small signals; rolling-shutter distortion in movement dynamics. By combining pixels (binning), a defectivity can be increased at very high rotation rates, and star position uncertainties can thus be counteracted. Star groups can be coded in a binary search tree. A search subject to tolerances can take place in the search tree. The found identification solution can be verified with further available stars.

Known properties of a calibrated star sensor, such as optics focal length, detector pixel size and number, can be included in the star group coding. Very fast star group identifications are possible by arranging star group codes in preferably binary search trees. Star identifications can be enabled in each individual and independent measuring cycle in real-time (<100 ms).

As soon as a star group (3 ... 4 stars) is detected, an identification and a position calculation can take place. If this takes place in directly consecutive cycles or at known time intervals, rotation rate, direction of rotation and rotation acceleration, or a rate estimation can be performed even for very high rotation rates. Conventional attitude tracking can be supported in particular at high rates and accelerations, which leads to an increase in the robustness of the position measurement.

The star group catalog data may include data on group stars, on star groups, and/or on a vector index tree. The data on the star groups may include identification vectors and/or reference data. The vector index tree can refer to the identification vectors of the star groups. Further star catalog data can be carried along and used with additional star data. The further star catalog data can be used as an extension. The position information can be statistically filtered. The position information can be filtered by averaging and/or Kalman filtering. At least one star camera, and in particular a rolling shutter camera, can be used to acquire the distorted star images. The distorted star images can be processed with the aid of the at least one star camera to form the distorted star group data. The at least one star camera may have image elements. Several mutually-adjacent image elements may be combined to form an image element module, in order to increase a rotation rate limit. A star camera or several star cameras may be used in a combined manner to detect different image fields. The method may be carried out with the aid of at least one separate processor device and/or with the aid of a processor device of the spacecraft.

The processing blocks may be logically, functionally, and/or structurally delimited. The processing blocks may be connected to one another in a signal-transmitting manner. The device may have several star cameras and a separate processor device for each star camera. The device may have several star cameras and a common processor device for a group of star cameras. The at least one processor device may be a separate processor device for carrying out the method, or a processor device of the spacecraft. The device may have at least one program memory and/or at least one data memory.

The computer program product may be present on a computer-readable storage medium, on a computer-readable data carrier, or as a data-carrier signal.

Embodiments of the invention are described in more detail below with reference to the figures.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 depicts a block diagram of a gyro-less position determination system for highly dynamic spacecraft,

FIG. 2 depicts a block diagram of a gyro-less position determination system for highly dynamic spacecraft, with only a rotation rate measurement,

FIG. 3 depicts a block diagram of the position determination system for less dynamic spacecraft,

FIG. 4 depicts a block diagram of a gyro-less position determination system for highly dynamic spacecraft, with an extra-precise position measurement,

FIG. 5 schematically illustrates star groups distorted by a rolling shutter,

FIG. 6 schematically illustrates identification parameters in star group data,

FIG. 7 is a flowchart of a processing in lost-in-space conditions,

FIG. 8 schematically illustrates an application of a robust rotation rate and position determination with a star sensor by means of selected star group catalog coding, and

FIG. 9 is a flowchart of a robust rotation rate and position determination with a star sensor by means of selected star group catalog coding.

### DETAILED DESCRIPTION

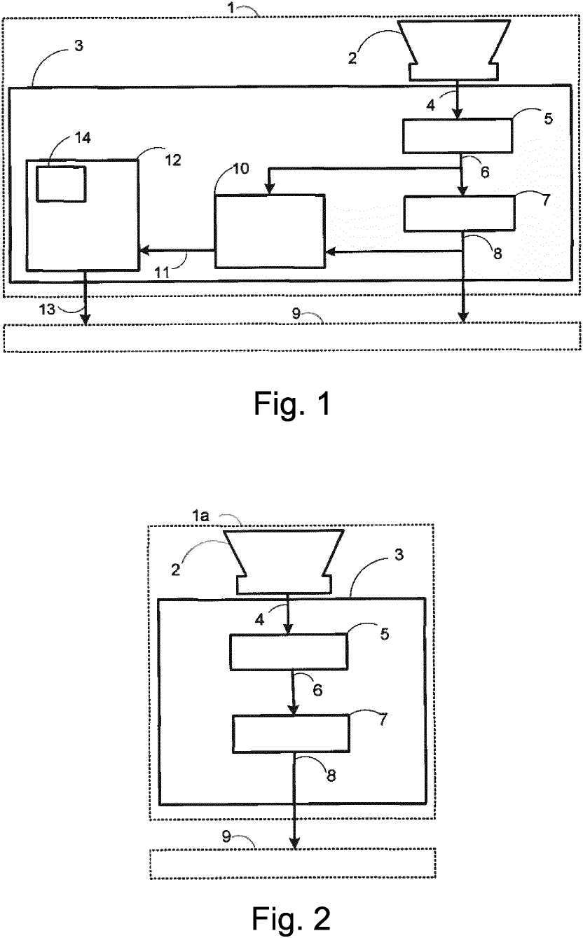

FIG. 1 shows a block diagram of a gyro-less position determination system 1 for highly dynamic spacecraft. A star camera 2 of the gyro-less position determination system 1, which is designed as a rolling shutter camera, acquires distorted star images 4 of the starry sky in time with the star sensor cycle and delivers them to a processor device 3 for evaluation. There, star vectors are determined from the star images 4 in a processing block 5 for star group generation, which star vectors characterize the position of all stars in the image and are processed further to form star group data 6. Similarly to the usual star images, star groups consist of three, four, or more stars and can be derived according to various principles. What is decisive is the property of the star groups that they can be unambiguously found in the entire starry sky with the aid of their star group parameters. Like the image, the star group data 6 are rolling-distorted and cannot be reliably used to search in star group catalog data 14. However, they can be identified in the quantity of the likewise-distorted star group data of the previous cycle. The distorted star group data 6 of the current image are therefore temporarily stored for the next cycle as distorted star group data of the previous cycle. If it is the very first cycle, i.e., lost-in-space conditions are present, there are no distorted star group data of the previous cycle. In this case, a current rotation rate 8 cannot be immediately calculated in the processing block 7. A rotation rate of zero angular degrees per second is in this case used as a fixed initial value. In subsequent cycles after the initialization, the current rotation rate can always be estimated in the processing block, for generating the current rotation rate 8. For this purpose, at least one star group from the current image is found again in the previous image. The determination of the current rotation rate from the matched distorted star groups is possible using various methods. In some variants of star groups, a direct calculation of the rotation rate from the star group parameters is possible. The use of the delta-quaternion estimation is always possible by statistical optimization of the rotation matrix, which brings the two sets of star vectors of the matched star groups as well as possible to congruence. The known QUEST algorithm can be used for this optimization.

The current rotation rate 8 determined in this way is, on the one hand, used for the geometric correction of the distorted star group data 6 in the processing block 10 for rolling shutter correction and is, on the other hand, output directly to the position control system 9 of the spacecraft. The current rotation rate 8 can be reliably measured from the second cycle on, even for very high rotation rates with an unstable axis of rotation, and is available to the spacecraft for applications with high rotation rates and low accuracy requirements. One such application of importance is the emergency with a fast-wobbling spacecraft, which can be stabilized again with the aid of the current rotation rate 8.

The processing block 10 for rolling shutter correction converts the star position of the stars of the star group data 6 into a coordinate system of the star sensor as it would come about in a snapshot without rolling shutter. The conversion takes place in relation to a well-defined reference time that is freely selectable in the star sensor cycle. For example, the middle of the exposure time of the first image line can be selected as the reference time. By means of a model of the rolling shutter, the time of its acquisition in relation to the reference time can, as a function of the number of the image line of the star, be determined as a time difference. Stars in the first image line have a difference of zero at the reference time mentioned. For each star of the groups, the current rotation rate 8 results in a rotation of its star vector, which puts the star vector into the position it had at the reference time. Stars from the first image line are not rotated at all; the stars from the last image line are subjected to the maximum rotation corresponding to the maximum time difference. The resulting rectified star group data 11 can now be found with success in the star group catalog data 14. This second matching of star groups takes place in the processing block 12 for generating the final position information. As a result of the matching, star vectors are then present both in the coordinate system of the star sensor at the reference time and in the inertial coordinate system of the catalog. This enables the calculation of the position information 13, consisting of the rotational position and precise rotation rate, according to known methods. In this case, a calculation of the position information 13 directly from the star group parameters or the use of the matched star vectors are possible. As a function of the actual current rotation rate, the catalog identification can also already work under lost-in-space conditions in the very first cycle, without measured current rotation rate. The rotational position part of the position information is thus available as of the first or second cycle. In the case of rotations below the previous rotation rate limit of conventional star sensors, the rotational position is immediately available, so that known disadvantages can be avoided.

The gyro-less position determination system can be adapted to special requirements of a mission, wherein the required resources are optimized according to the adaptation.

FIG. 2 shows a block diagram of a gyro-less position determination system 1 a for highly dynamic spacecraft with only a rotation rate measurement. Here, all components of the system that are not required for the measurement of the current rotation rate 8 can be omitted. The remaining components do not require any modification, so that a high degree of modularity of the system is achieved.

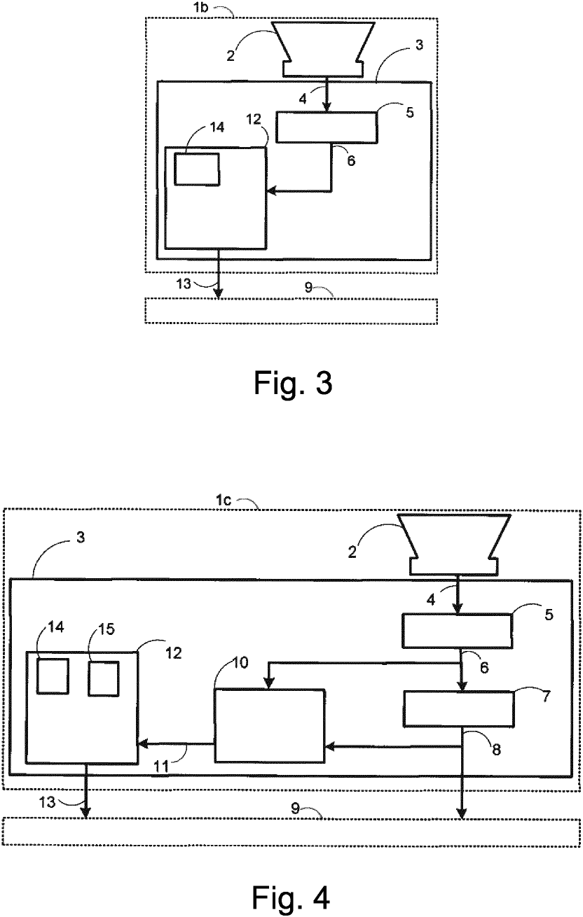

FIG. 3 shows a block diagram of the position determination system 1 b for less dynamic spacecraft. Here, the system components for determining the current rotation rate 8 and for the processing block 10 for rolling shutter correction are omitted - likewise in a modular manner. If the system is to be upgraded for higher requirements, corresponding extensions are possible, as shown in FIG. 4 for the case of the gyro-free position determination system for highly dynamic spacecraft with extra precise position measurement.

The measurement accuracy can be increased by using additional star catalog data 15. With the number of matched stars, the accuracy of both the rotational position measurement and the rotation rate measurement is improved. The number of the matched stars is now no longer limited, as with conventional star sensors, by the capacity of the tracking of stars in image windows. It can potentially be extended to all detectable stars in the image. The number of the measured stars thereby increases, e.g., to about 50 to 100, compared to 16 stars tracked in windows. This leads to a significant increase in the measurement accuracy.

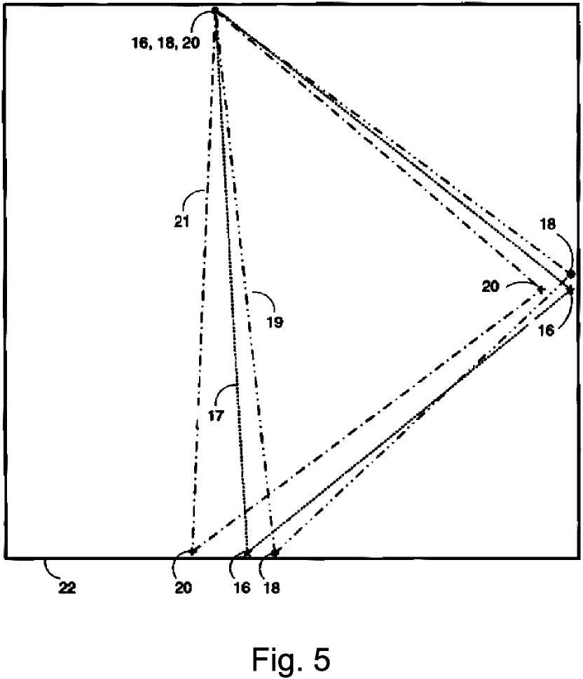

FIG. 5 shows two examples of star groups distorted by the rolling shutter. The non-distorted star group 17 is also shown for comparison. The non-distorted star group 17 consists of the three stars 16. The star group 19 with the stars 18 demonstrates the distortion by a rotation about the optical axis of the star camera, while the star group 21 with the stars 20 shows the distortion by a rotation about the vertical image axis of the star camera. The image ratios correspond to a typical case with a square star camera image field 22 of 25 angular degrees, a rolling shutter delay of 100 milliseconds between the first and the last image lines in an 8 Hz star sensor cycle. The first image line is located at the top in the image. In the case of an assumed size of the image matrix of 1,000 image elements times 1,000 image elements, a distortion of about 80 image elements for a rotations around the image axis and of about 34 image elements for a rotation about the optical axis of the star camera results in the last image line in each case at a rotation rate of 20 angular degrees per second. FIG. 5 reflects the geometric proportions of the distortion for these cases. As a function of the rotation rate and the axis of rotation, corrections for the star positions result, which can be compensated for only with the rotation corresponding to all three components of the current rotation rate 8, as they are carried out in the processing block 10. Mere shifts are not sufficient.

For the star groups, four stars are preferably used. In the case of the use of three stars per group, there is theoretically already a clear identification of the group, but very small errors in the determination of the star position are required for this purpose, which cannot always be ensured in practice. The star group data include the identification parameters, combined in an identification vector. Furthermore, they can include reference data which are used for the rotational position and rotation rate calculation after successful identification. For large sets of star group data, such as star group catalog data 14, index trees can additionally be included to accelerate the search.

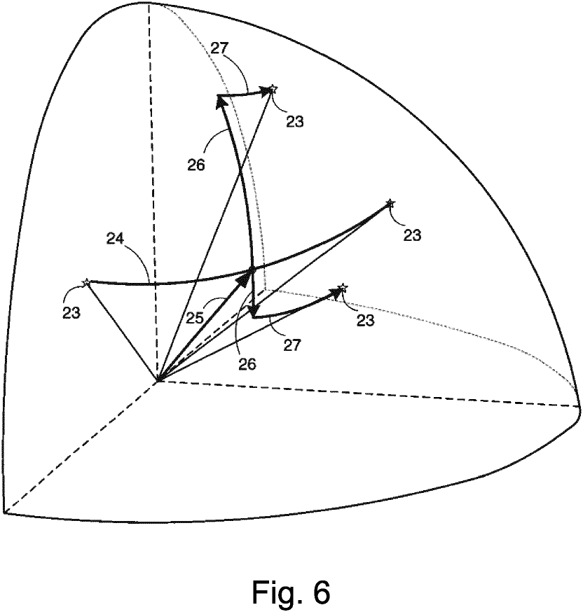

FIG. 6 shows identification parameters in star group data. For star calculations, data relating to the unit sphere with unit vectors and solid angles are preferably used. The star group considered consists of four stars 23, the position of which is represented as a direction by the corresponding star vector on the unit sphere. The star vectors of the stars in the image of the star camera are determined by the position of the star in the image and the optical imaging parameters -especially the focal length and possibly further calibration parameters. In the example shown in FIG. 6, the identification parameters are calculated as follows: First, the two stars with the greatest angular separation are selected; they are called primary stars. The spherical primary axis 24 of the star group is the circular segment on the unit sphere that connects the two stars with the greatest separation angle. The length of the primary axis corresponds to the maximum separation angle. The unit vector to the center of the primary axis is used as a position vector 25 of the group. The spherical secondary axis is perpendicular to the primary axis and has its origin in the position vector of the group. With these two axes, the angular coordinates of the two remaining stars of the group, called secondary stars, are then defined in a local group coordinate system. The group coordinate system is two-dimensional, with the angular coordinates perpendicular to the primary axis 26 and the angular coordinates parallel to the primary axis 27. In order to make the group identification independent of the image scale of the star camera, or to perform a recalibration of the focal length in orbit, the angular coordinates of the secondary stars can additionally be normalized to the angular size of the primary axis. After identification, changes in scale, e.g., as a result of thermal effects in the objective, can then be compensated for by evaluation of the non-normalized angles. In this case, the variant, independent of the image scale, of the identification is to be used with the angles normalized to the primary axis.

The four values of the angular coordinates (primary axes 26, 27) of the two secondary stars form the four-dimensional identification vector of the star group. The indices of the four group stars in the index list of the stars detected in the image are the reference data. The global star group catalog with the star group catalog data 14 is calculated with the same method on the ground, and is carried along in flight. The indices of the four stars correspond to a continuous numbering of all group stars in the star group catalog data 14. The index tree, which is likewise calculated on the ground, is preferably designed as a vector index tree for the specified identification vector. In addition to the star group catalog data 14, additional star catalog data 15 are carried along for the variant of the gyro-less position determination system 1c for highly dynamic spacecraft with an extra precise position measurement.

In the case of star detection with windows, the typical star sensor is not suitable for very high rotation rates for geometric reasons, and possible modifications of the sensor configuration must be considered. An improvement that is easy to implement results from the enlargement of the image field. In a star camera with a square image field of 40 angular degrees, only about 1,000 stars are required in the catalog for the star groups. The result is a rotation rate limit of 14 angular degrees per second with an image exposure of 100 milliseconds. Even larger image fields result in a further increase in the theoretical rotation rate limit. The approximate uniform distribution of the stars assumed here is practically not present. For this reason, in the design of the star catalog and of the star group catalog for high rotation rates, the star distance must be considered in particular. Stars with near neighbors must not be used for the catalog. Since all stars are detected in the image of the star camera - even the unsuitable ones - a moderately increased processing capacity in the processing block 7 of the star group generation additionally results. Overall, the desired rotation rate limit of 20 angular degrees per second for the emergency regime in a simple, typical star sensor with window detection can be achieved with the aid of an image field enlargement, an adapted catalog design, and increased computing power.

Newer star sensors no longer work with star windows, but with star clusters. Clusters are groups of coherent, bright image elements, which are extracted as objects from the image.

In the continuation of the measurement of rotational position and rotation rate with the method of the invention in a continuous sequence, a measurement is possible in each star sensor cycle, regardless of how the rotation rate below the limit changes. In the first measurement under lost-in-space conditions, it can happen that, at high rotation rates, a measurement result is available only in the second cycle. The cause of the possible failure of the very first cycle is the missing star image from the previous cycle.

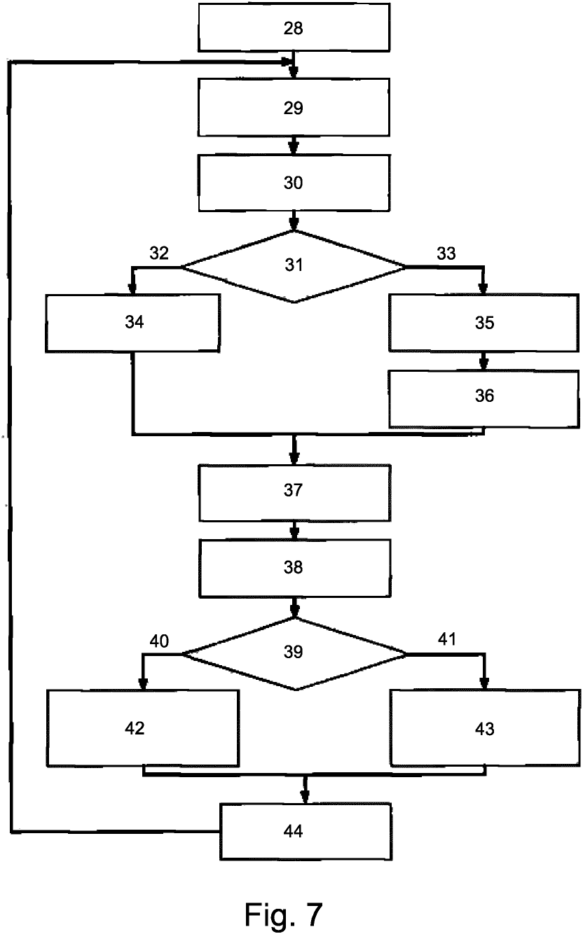

FIG. 7 shows a flowchart of a processing with lost-in-space conditions in the very first star sensor cycle. In the very first cycle, the current rotation rate for rolling correction is set to zero. This can take place by direct assignment of the zero value, or by using the data of the current cycle instead of the star groups of the previous cycle. With a zero rotation rate, the rolling shutter correction does not change the data. A measurement result in the first cycle will therefore only be available if the rotation rate leads to tolerable distortions. At a rotation rate of 1 angular degree per second and an extension of the star group over half the image field, a distortion of about 2 image elements occurs in the typical star sensor. 2 image elements of geometric errors generally result in failure of the identification. Nevertheless, in practice, rotation rates of 1 to 4 angular degrees per second can be tolerated for the star identification in a typical star sensor. This is because the rolling distortion can act partially as a rotation and enlargement. These components of the distortions are compensated for by the identification algorithms.

In the flow chart according to FIG. 7, there is a success check of the matching of the rectified star groups to the catalog. It is in particular required for the very first processing cycle. A success check of the matching of the star groups from the current and the last image is not required. The matching of the distorted star groups of two consecutive images works for all relevant usage scenarios of the star sensor. During a rotation about the image axes, the time differences of the star detection do not change. In this most favorable case, there is no change in the rolling distortion from image to image. The greatest change in the rolling distortion exists during the rotation about the optical axis of the star camera. It is less than one third of the image element at a rotation rate of 20 angular degrees per second, and is thus not critical.

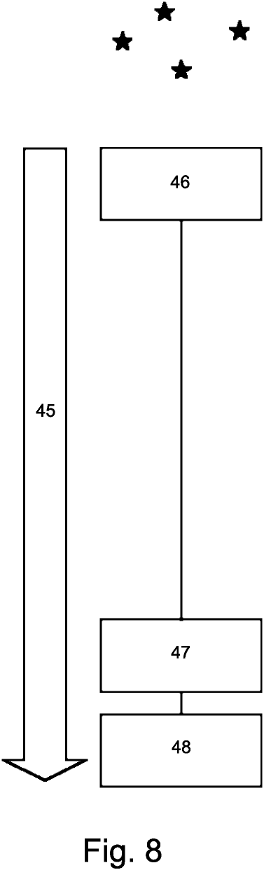

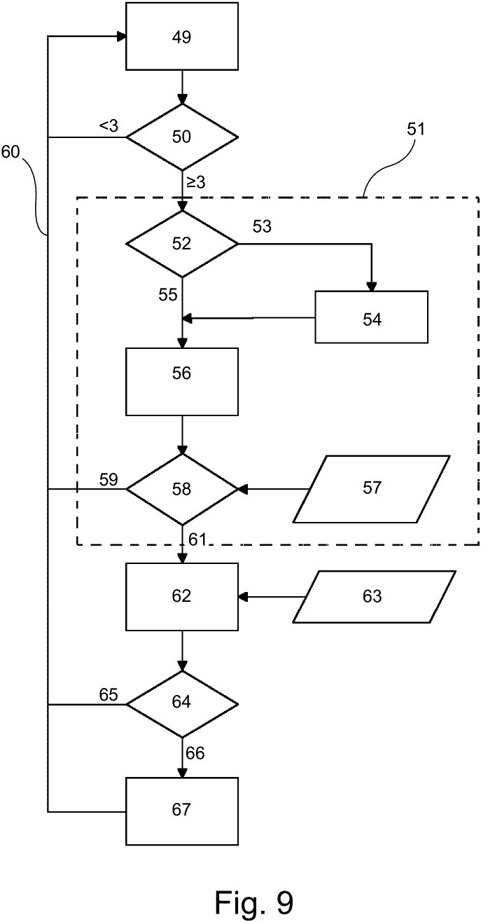

FIG. 8 shows an application of a robust rotation rate and position determination with a star sensor by means of selected star group catalog coding. FIG. 9 shows a flowchart of robust rotation rate and position determination with a star sensor by means of selected star group catalog coding.

As derived from the method according to FIG. 8 and FIG. 9, the known properties of a calibrated star sensor, such as optics focal length, detector pixel size and number, are included in the star group coding. The arrangement of the star group code in preferably binary search trees enables very fast star group identifications. The method was optimized and verified on real measurement data. This proposal enables real-time star identifications in each individual and independent measuring cycle (<100 ms). That is to say, as soon as a star group (3 ... 4 stars) is detected, an identification and position calculation can take place. If this takes place in directly consecutive cycles or with known time intervals, rotation rate, direction of rotation and rotation acceleration, or rate estimation can be performed even for very high rotation rates. The conventional attitude tracking can be supported with this method - in particular, at high rates and accelerations - which leads to an increase in the robustness of the position measurement. These properties are a valuable extension of the functionality of a star sensor.

The word “may” refers in particular to optional features of the invention. Accordingly, there are also further developments and/or embodiments of the invention which additionally or alternatively have the respective feature or the respective features.

If necessary, isolated features can also be selected from the combinations of features disclosed in the present case and can be used in combination with other features to delimit the subject matter of the claim, while resolving a structural and/or functional relationship that may exist between the features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

Reference signs

| | |
|---|---|
| 1 | Position determination system |
| 1 a | Position determination system |
| 1 b | Position determination system |
| 1 c | Position determination system |
| 2 | Star camera |
| 3 | Processor device |
| 4 | Star image |
| 5 | Processing block |
| 6 | Star group data |
| 7 | Processing block |
| 8 | Rotation rate |
| 9 | Position control system |
| 10 | Processing block |
| 11 | Star group data |
| 12 | Processing block |
| 13 | Position information |
| 14 | Star group Catalog data |
| 15 | Star catalog data |
| 16 | Star |
| 17 | Star group |
| 18 | Star |
| 19 | Star group |
| 20 | Star |
| 21 | Star group |
| 22 | Image field |
| 23 | Star |
| 24 | Primary axis |
| 25 | Position vector |
| 26 | Primary axis |
| 27 | Primary axis |
| 28 | Start of measurement, cycle number=0 |
| 29 | Calculation of the star vectors from the image |
| 30 | Calculation of the star groups from the star vector |
| 31 | Cycle number=0 |
| 32 | Yes |
| 33 | No |
| 34 | Current rotation rate=0 |
| 35 | Matching of the current and the previous star groups |
| 36 | Calculation of the current rotation rate |
| 37 | Rolling shutter correction of the star group |
| 38 | Matching of the corrected and the catalog star groups |
| 39 | Sucessful match? |
| 40 | No |
| 41 | Yes |
| 42 | Notification of a measurement error to the satellite |
| 43 | Final calculation of rotational position and rotation rate, and notification to the satellite |
| 44 | Cycle number=cycle number+1 |
| 45 | Execution of the method according to the invention, duration < 100 ms (real-time) |
| 46 | Detect (x, y) |
| 47 | Identify |
| 48 | Calculate position |
| 49 | Detector, binning stage 1, 2, 4 |
| 50 | # of objects? |
| 51 | Identify |
| 52 | Rate exists |
| 53 | Yes |
| 54 | Rolling shutter correction |
| 55 | No |
| 56 | Image star group code(s) |
| 57 | Catalog star group mempry |
| 58 | Star group ID? |
| 59 | No |
| 60 | Next cycle |
| 61 | Yes |
| 62 | Store position of cycle N |
| 63 | Guide star catalog |
| 64 | N-1 positions exist? |
| 65 | No |
| 66 | Yes |
| 67 | Calculate rate and direction |

What is claimed is:

1-15. (canceled)

16. A method for determining the position and orientation of a spacecraft in space, the method comprising at least one of:
A) cyclically repeatedly acquiring distorted star images with at least one star camera;
processing the distorted star images of a current cycle with a computer to form rectified star group data;
determining position and orientation information by matching the rectified star group data with star group catalog data stored in a database; and
transmitting the position and orientation information to a position control system of the spacecraft; or
B) performing one of the following:
i) coding star group catalog data for a star group having 3 to 4 stars that are visible in an image field, wherein each star is defined by 3 coordinates, into representative focal-plane coordinates, and
forming a scaling- invariant, translation- invariant, and rotation-invariant star group code based on the focal plane coordinates; or
ii) coding star group catalog data for a star group having 3 to 4 stars that are visible in an image field, wherein each star is defined by 3 coordinates, into at least one of representative tangent coordinates or representative angular coordinates.

17. The method of claim 16, further comprising:
cyclically repeatedly performing:
processing the acquired distorted star images on the computer to form distorted star group data, and
storing the distorted star group data;
determining a current rotation rate of the spacecraft by comparing the distorted star group data of two consecutive cycles; and
transmitting the current rotation rate to the position control system.

18. The method of claim 16, wherein at least one of:
the database in which the star group catalog data is stored is carried onboard the spacecraft; or
the computer is carried onboard the spacecraft.

19. The method of claim 16, wherein:
the star group catalog data includes data on group stars, on star groups, and on a vector index tree;
the data on the star groups include identification vectors and reference data; and
the vector index tree relates to the identification vectors of the star groups.

20. The method of claim 16, wherein:
the database in which the star group catalog data is stored is carried onboard the spacecraft; and
star catalog data are carried onboard the spacecraft and is used with additional star data to determine the position and orientation of the spacecraft.

21. The method of claim 16, further comprising statistically filtering the position and orientation information.

22. The method of claim 21, wherein the position and orientation information is filtered over at least one of several cycles, or over several star cameras.

23. The method of claim 16, wherein the at least one star camera includes at least one rolling shutter star camera.

24. The method of claim 17, wherein processing the distorted star images comprises processing the images with the aid of the at least one star camera to form the distorted star group data.

25. The method of claim 17, wherein:
the at least one star camera has image elements; and
several mutually-adjacent image elements are combined to form an image element module, in order to increase a rotation rate limit.

26. The method of claim 16, further comprising:
detecting different image fields using one or more star cameras in a combined manner.

27. The method of claim 16, wherein at least one of:
the method is carried out with the aid of at least one separate processor device; or
the method is carried out with the aid of a processor device of the spacecraft.

28. A device for determining the position and orientation of a spacecraft in space from repeatedly acquired distorted star images, the device comprising:
at least one star camera configured for acquiring the distorted star images; and
at least one processor device;
wherein the at least one processor device comprises at least one of:
a) a first processing block configured for cyclically repeatedly:
acquiring distorted star images, processing the distorted star images to form distorted star group data, and storing the distorted star group data, and
a second processing block for determining a current rotation rate by comparing the distorted star group data of two consecutive cycles; or
b) a third processing block for processing the distorted star images of a current cycle to form rectified star group data, and
a fourth processing block for determining position and orientation information by matching the rectified star group data with star group catalog data stored in a database.

29. The device of claim 28, wherein the at least one star camera is a rolling shutter camera.

30. The device of claim 28, comprising:
a plurality of star cameras and a separate processor device for each star camera; or
a common processor device for a group of star cameras.

31. The device of claim 28, wherein the at least one processor device is at least one of:
a processor device separate from the spacecraft; or
a processor device of the spacecraft.

32. A computer program product comprising program code stored on a non-transient, computer-readable medium, the program code, when executed by a computer, causing the computer to carry out the method of claim 16.
